(19) United States
(12) Patent Application Publication
(10) Pub. No.: US 2017/0337203 A1
(43) Pub. Date: Nov. 23, 2017

(54) EVALUATION PROGRAM, EVALUATION METHOD, AND INFORMATION PROCESSING DEVICE

(71) Applicant: FUJITSU LIMITED, Kawasaki-shi (JP)

(72) Inventors: Kento UEMURA, Kawasaki (JP); Yuiko Ohta, Kawasaki (JP); Keisuke Goto, Kawasaki (JP); Hiroya Inakoshi, Tama (JP)

(73) Assignee: FUJITSU LIMITED, Kawasaki-shi (JP)

(21) Appl. No.: 15/496,591

(22) Filed: Apr. 25, 2017

(30) Foreign Application Priority Data
May 18, 2016 (JP) 2016-099876

(51) Int. Cl. G06F 17/30

(52) U.S. Cl. CPC G06F 17/3053; G06F 17/30985; G06F 17/30315; G06F 17/30554

(57) ABSTRACT

An evaluation method which is executed by a processor, the method includes: comparing values of cells between a plurality of pieces of data each including a plurality of cells divided by a plurality of columns and a plurality of records; storing, in a storage unit, information that indicates a plurality of cell sets that have been detected as sets of cells including similar character strings by the comparing; and setting, with reference to the storage unit, a score of each of a plurality of column sets formed by making each of columns of one of the plurality of pieces of data and each of columns of another one of the plurality of pieces of data as a set, based on a score for a record set of records in which a cell set, among the plurality of cell sets, which is included in the column set is included.

### CROSS-REFERENCE TO RELATED APPLICATION

This application is based upon and claims the benefit of priority of the prior Japanese Patent Application No. 2016-099876, filed on May 18, 2016, the entire contents of which are incorporated herein by reference.

### FIELD

The embodiments discussed herein are related to an evaluation program, an evaluation method, and an information processing device.

### BACKGROUND

For example, in a business system, various types of information used in business is registered and managed as master data. Also, there are cases where a plurality of business systems is integrated, and due to the integration, name identification of a plurality of pieces of master data is performed. In name identification, for example, between one master data and another master data, columns that have corresponding contents are associated. Japanese Laid-open Patent Publication No. 2012-234343, Japanese Laid-open Patent Publication No. 2008-27072, Japanese Laid-open Patent Publication No. 2012-14684, Japanese Laid-open Patent Publication No. 2004-086782, and Japanese Laid-open Patent Publication No. 2007-188343 discuss related art.

For example, as a method for associating columns between pieces of data for name identification, values of cells which belong to columns are compared to one another between pieces of data and columns including many sets of cells from which similar character strings have been detected are associated with one another. However, for example, there are cases where, although one column of one data and another column of another data do not correspond to one another, the values of cells which belong to the columns are similar to one another. For example, assuming a case where there are a column in which the address of a company is registered and a column in which the address of a person in charge is registered, respective pieces of information of the columns are similar to one another from a point of view of address. Therefore, these columns might have similar values in the columns of the cells and thus there is a probability that the columns are associated with one another, but the address of a company and the address of an individual are associated with one another, and therefore, this association is improper. Also, as another example, there are cases where numeric strings of serial numbers are assigned to records of pieces of data. In such a case, an assigned numeric string might be similar to a numeric string assigned in another data and there is a probability that the columns thereof are associated with one another, but the serial numbers have different meaning for each piece of data and the association of the columns is improper as association of columns. As described above, there are cases where, even when values of cells which belong to columns are similar to one another, the serial numbers have different meaning for each piece of data, thus resulting in improper association of columns. Therefore, for example, it is desired to provide a technology that enables association of columns between a plurality of pieces of data with high accuracy.

In one aspect, it is therefore an object of the present disclosure to provide a technology that enables association of columns between a plurality of pieces of data with high accuracy.

### SUMMARY

According to an aspect of the invention, an evaluation method includes: comparing values of cells between a plurality of pieces of data each including a plurality of cells divided by a plurality of columns and a plurality of records; storing, in a storage unit, information that indicates a plurality of cell sets that have been detected as sets of cells including similar character strings by the comparing; and setting, with reference to the storage unit, a score of each of a plurality of column sets formed by making each of columns of one of the plurality of pieces of data and each of columns of another one of the plurality of pieces of data as a set, based on a score for a record set of records in which a cell set, among the plurality of cell sets, which is included in the column set is included.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are tables illustrating an example of a character string match result;

FIGS. 2A and 2B are tables illustrating an example of column set association according to an embodiment;

FIG. 3 is a diagram illustrating an example of a functional block configuration of an information processing device according to some embodiments;

FIG. 4 shows tables illustrating an example of character string match and a character string match result;

FIGS. 5A and 5B are tables illustrating respective examples of column set score information and record set score information;

FIG. 6 shows tables illustrating an example of a calculation of a score of a record set using scores of column sets;

FIG. 7 shows tables illustrating an example of a calculation of a score of a column set using scores of record sets;

FIG. 8 is a table illustrating an example of ranking of column sets;

FIG. 9 is a diagram illustrating an example of record set association;

FIG. 10 shows tables illustrating another example of character string match and a character string match result;

FIG. 11 shows tables each illustrating an example of a calculation of a score of a column set;

FIGS. 12A to 12C are tables each Illustrating an example of ranking of column sets;

FIG. 13 is a flowchart illustrating an example of an operation flow of evaluation processing according to an embodiment; and

FIG. 14 is a diagram Illustrating an example of a hardware configuration of a computer that realizes an Information processing device according to an embodiment.

### DESCRIPTION OF EMBODIMENTS

Some embodiments according to the present disclosure will be described in detail below with reference to the accompanying drawings. Note that corresponding elements in a plurality of drawings are denoted by the same reference character.

As described above, for example, for data in table form or in matrix form, for name identification, as a method for associating a column (also called as an attribute) with another column between pieces of data, values of cells which belong to columns between pieces of data are compared to one another, and columns that include many sets of cells from which similar character strings have been detected are associated with one another. Note that target data on which column association is performed may be data, such as, for example, a database, a table, or the like. Data may be, for example, master data. Also, although a case where, assuming that two pieces of data are targets, column association is performed between the pieces of data will be described as an example below, the present disclosure is not limited thereto and, assuming that three or more pieces of data are targets, column association may be executed between pieces of data.

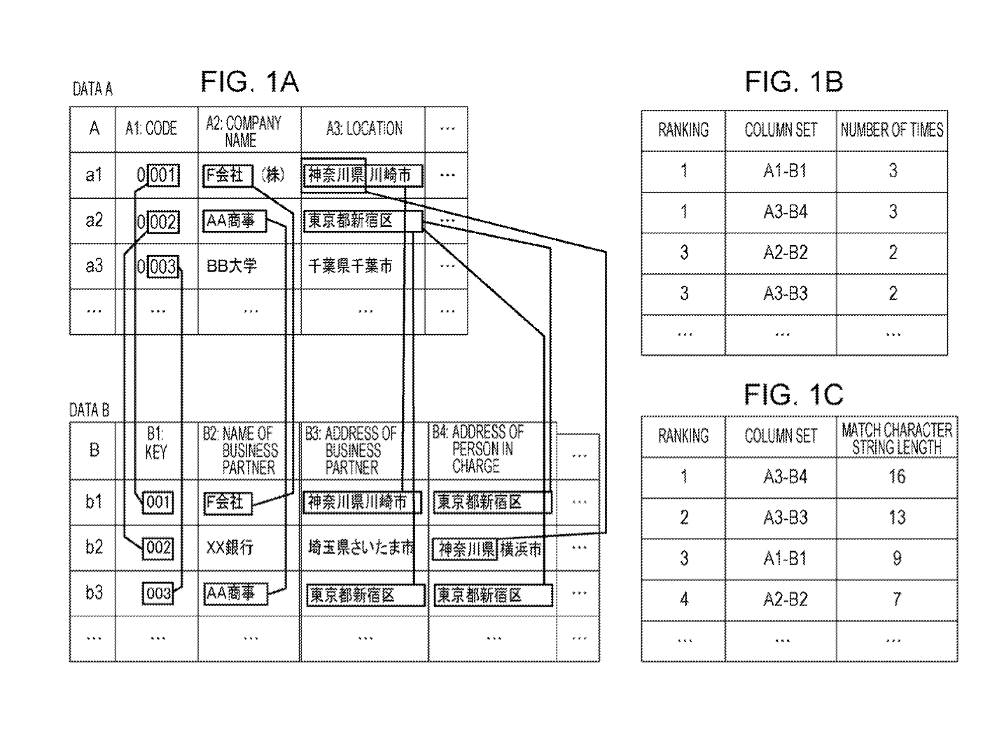

FIGS. 1A to 1C are tables illustrating an example of column association and, in FIG. 1A, DATA A and DATA B are illustrated. Note that, in the following description, in data, separated columns will be referred to as columns. For example, in DATA A, “A1: CODE”, “A2: COMPANY NAME”, “A3: LOCATION”, . . . are columns. Also, in the following description, each column will be occasionally referred to such that a part of the name of the column is omitted and, for example, “A1: CODE” and “A2: COMPANY NAME” will be occasionally referred to as “A1” and“A2” respectively tat, in the columns A2 and B2, “F [symbol] ”, “F [symbol] ( [symbol] )”, “AA [symbol] ”, “BB [symbol] ”, and “XX [symbol] ” are “F Company”, “F Company Limited”, “AA Trading”, “BB University”, and “XX Bank”, respectively. In the columns A3, B3, and B4, addresses are written in Chinese characters, but the details thereof will be omitted.

On the other hand, in the following description, separated rows will be referred to as records. For example, in DATA A, “a1”, “a2”, “a3”, . . . are records. Also, in the following description, areas which are divided by columns and records and store values will be referred to as cells. In the following description, between a plurality of pieces of data, that is, DATA A and DATA B, or the like, a set of single columns will be occasionally referred to as a column set. For example, each of a plurality of columns of DATA A is made as a set with each of a plurality of columns of DATA B, and thereby, a plurality of column sets is made. Similarly, between a plurality of pieces of data, a set of single records will be occasionally referred to as a record set, for example, each of a plurality of records of DATA A is made as a set with each of a plurality of records of DATA B, and thereby, a plurality of record sets is made.

In this case, in the example of FIGS. 1A to 1C, it is assumed that the column “A2: COMPANY NAME” of DATA A forms, with the column “B2: NAME OF BUSINESS PARTNER” of DATA B, a proper column set in which the contents of both of the columns correspond to one another. It is also assumed that the column “A3: LOCATION” of DATA A forms, with the column “B3: ADDRESS OF BUSINESS PARTNER” of DATA B, a proper column set in which the contents of both of the columns correspond to one another.

Also, FIGS. 1A to 1C illustrate a result of character string match executed between DATA A and DATA B. In character string match, for example, values of cells are compared between a plurality of pieces of data and character strings that match are detected. As a result of character string match, match character strings are extracted from the plurality of pieces of data. Match character strings may be, for example, character strings that match between a plurality of pieces of data, which have been found as a result of character string match, and furthermore, may be common character strings that completely match or character strings similar to one another, which have been detected by fuzzy association. In FIG. 1A, detected match character strings are connected to one another by a line. Then, when the number of match character strings between each column of DATA A and the corresponding column of DATA B is counted, between the column A1 and the column B1, match character strings have appeared tree times (for example, 001, 002, and 003). Similarly, between the column A2 and the column B2, match character strings have appeared twice (for example, F [symbol] and AA [symbol] ). Then in the above-described manner, the number of match character strings between each column of DATA A and the corresponding column of DATA B, which have appeared, is acquired, column sets are ranked in accordance with the acquired number of match character strings, which have appeared, and thus, a result Illustrated in FIG. 1B is achieved.

In FIG. 1B, for example, for the column “A2: COMPANY NAME” of DATA A, a plurality of match character strings has been detected only with the column “B2: NAME OF BUSINESS PARTNER” of DATA B. It is therefore expected that there is a high probability that these columns are associated to one another. As described above, association of the column “A2: COMPANY NAME” of DATA A and the column “B2: NAME OF BUSINESS PARTNER” of DATA B is proper, and it is possible to estimate corresponding columns between a plurality of pieces of data, based on match character strings in the above-described manner.

However, for the column “A3: LOCATION” of DATA A, a plurality of match character strings with both of the column “B3: ADDRESS OF BUSINESS PARTNER” and the column “B4: ADDRESS OF PERSON IN CHARGE” of DATA B have been detected. As described above, in the example of FIGS. 1A and 1B, the column “A3: LOCATION” of DATA A forms a proper column set with the column “B3: ADDRESS OF BUSINESS PARTNER” of DATA B in which the contents of both of the columns correspond to one another. However, in FIG. 1B, a higher ranking is given to a set of the column “A3: LOCATION” of DATA A and the column “B4: ADDRESS OF PERSON IN CHARGE” of DATA B. As described above, when ranking is performed in accordance with the number of match character strings to determine a corresponding column set, there are cases where columns in a wrong column set are associated with one another.

Also, as another example, when the number of characters of match character strings is counted, between the column A1 and the column B1, the number of characters of match character strings is nine characters, which is the total of three characters of “001”, three characters of “002”, and three characters of “003”. Similarly, between the column A2 and the column B2, the number of characters of match character strings is seven characters, which is the total of three characters of “F [symbol] ” and four characters of “AA [symbol] ” The number of characters of match character strings between columns of DATA A and DATA B is acquired in the manner described above and columns sets are ranked in accordance with the number of characters of match character strings, which has been acquired, so that a result Illustrated in FIG. 1C is achieved. Note that, when comparison between English sentences is performed, instead of the number of characters, the number of words may be compared.

Also, in this case, although the column “A3: LOCATION” of DATA A corresponds to the column “B3: ADDRESS OF BUSINESS PARTNER” of DATA B, in FIG. 1C, a higher ranking than the ranking of the above-described column set is given to a set of the column “A3: LOCATION” of DATA A and the column “B4: ADDRESS OF PERSON IN CHARGE”. As described above, for example, also when ranking is performed in accordance with the number of match character strings to determine a corresponding column set, there are cases where columns in a wrong column set are associated with one another. Therefore, it is desired to provide a technology that enables association of a set of columns between pieces of data with high accuracy.

For example, in many cases, name identification is originally executed on data including many corresponding columns and records. For a record set of proper association, there is a tendency that match character strings are found in a plurality of columns. Therefore, for example, there is a tendency that, assuming a case where a column set in which columns are associated with one another using match character strings is a proper column set, seeing a record set including match character strings included in the column set, match character strings are also found in another column.

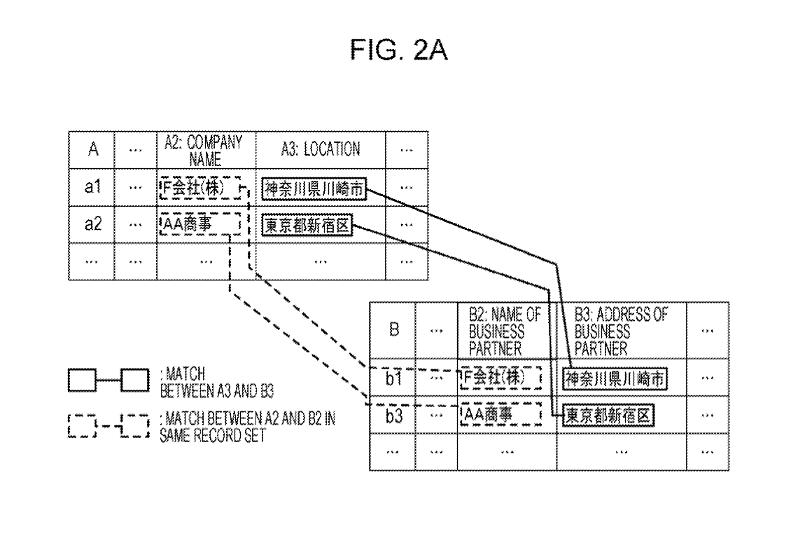

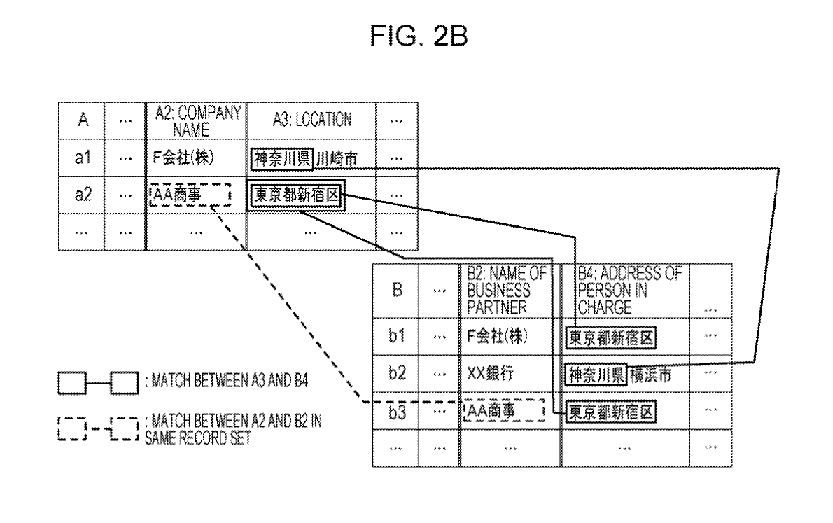

For example, in the column set of the column “A3: LOCATION” and the column “B3: ADDRESS OF BUSINESS PARTNER”, which has many matches in FIGS. 1A to 1C, records that include match character strings are compared to one another. Then, as illustrated in FIG. 2A, in two records sets that include match character strings, “A2: COMPANY NAME” and “B2: NAME OF BUSINESS PARTNER” also match.

On the other hand, for example, in the column set of the column “A3: LOCATION” and the column “B4: ADDRESS OF PERSON IN CHARGE”, which has many matches in FIGS. 1A to 1C, records that include match character strings are compared to one another. Then, as illustrated in FIG. 2B, among three record sets that correspond to the match character strings, the column “A2: COMPANY NAME” and the column “B2: NAME OF BUSINESS PARTNER” match only in one record set of “AA [symbol] ”. In this case, it is estimated that reliability is higher for the column set of “A3: LOCATION” and “B3: ADDRESS OF BUSINESS PARTNER” for which there are more matches in more record sets than for the column set of “A3: LOCATION” and “B4: ADDRESS OF PERSON IN CHARGE”.

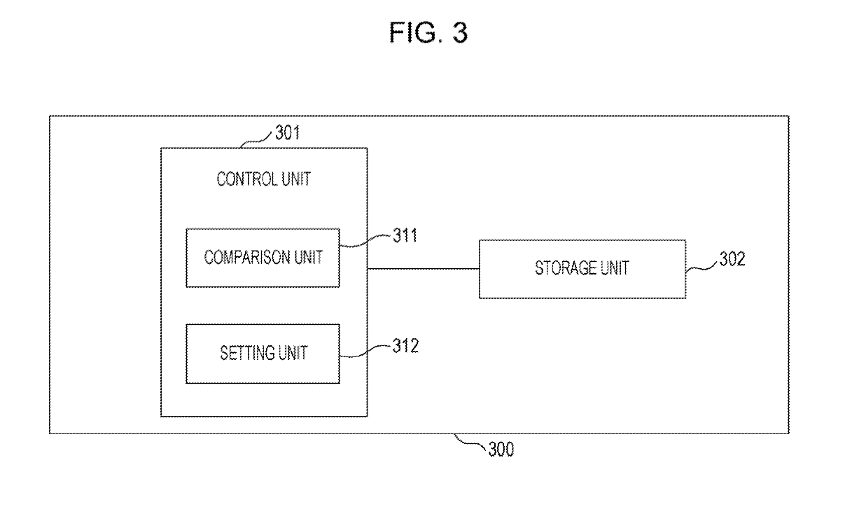

In embodiments that will be described below, for example, scores of column sets are set such that a higher score is given to a column set in which a set of cells (which will be hereinafter occasionally referred to as a cell set) including match character strings in a record set the score of which is higher appears. Also, scores of record sets are set such that a higher score is given to a record set in which a cell set including match character strings in a column the score of which is higher appears. Thus, considering the above-described tendency that, “in a properly associated record set, match character strings are found in a plurality of columns”, the scores of column sets may be evaluated and, as a result, it is enabled to associate a set of columns with high accuracy using the scores of the column sets. Embodiments will be described further in detail below with reference to FIG. 3 to FIG. 14.

FIG. 3 is a diagram illustrating an example of a functional block configuration of an information processing device 300 according to an embodiment. The Information processing device 300 may be, for example, a device that processes information of a personal computer (PC), a note PC, or the like. The information processing device 300 includes, for example, a control unit 301 and a storage unit 302. The control unit 301 may be configured to, for example, control each unit of the information processing device 300. The control unit 301 includes, for example, a comparison unit 311 and a setting unit 312. The storage unit 302 may be configured to store information, such as, for example, target data on which column association is performed, a result M of character string match, column set score information 501, a record set score information 502, or the like, which will be described later. Details of each unit of the control unit 301 and details of information stored in the storage unit 302 will be described later.

Subsequently, calculations of the score of a column set and the score of a record set according to the embodiment will be described. As described above, for example, values of cells are compared to one another between two pieces of data (for example, DATA A and DATA B) and character string match is executed, thereby enabling detection of match character strings that math between the two pieces of data.

The result M of character string match may be expressed by, for example, M={m₁, m₂, . . . , mₖ, . . . , m_{μ}}. In this case, mₖ (1≦k≦μ) is information related to a match character string detected by character string match. Note that p may be the total number of match character strings detected by character string match. Also, k may be an index assigned to a match character string. Each element of mₖ may be expressed by mₖ=(iₖ, jₖ, uₖ, vₖ, sₖ). In this case, iₖ may be information used for identifying a record in DATA A of a cell that includes a match character string of mₖ and, for example, may be a1, a2, . . . or the like, which is an identifier of a record of DATA A. jₖ may be information used for identifying a record in DATA B of a cell that includes a match character string of mₖ and, for example, may be b1, b2, . . . or the like, which is an identifier of a record of DATA B. Also, uₖ may be information used for identifying a column in DATA A of a cell that includes a match character string of mₖ and, for example, may be A1, A2, . . . or the like, which is an identifier of a column of DATA A. vₖ may be information used for identifying a column in DATA B of a cell that includes a match character string of mₖ and, for example, may be B1, B2, . . . or the like, which is an identifier of a column of DATA B. sₖ is a score that corresponds to mₖ and a value that determines reliability of mₖ. Sₖ may be determined in advance. For example, when all of match character strings that have been detected by character string match are equivalently treated, a value (for example, sₖ=1) that is common to all of sₖ may be set. As another option, in a case where, the longer the character length of a match character string is, the more important match character string the match character string is treated as, sₖ=the match character sting length may be employed.

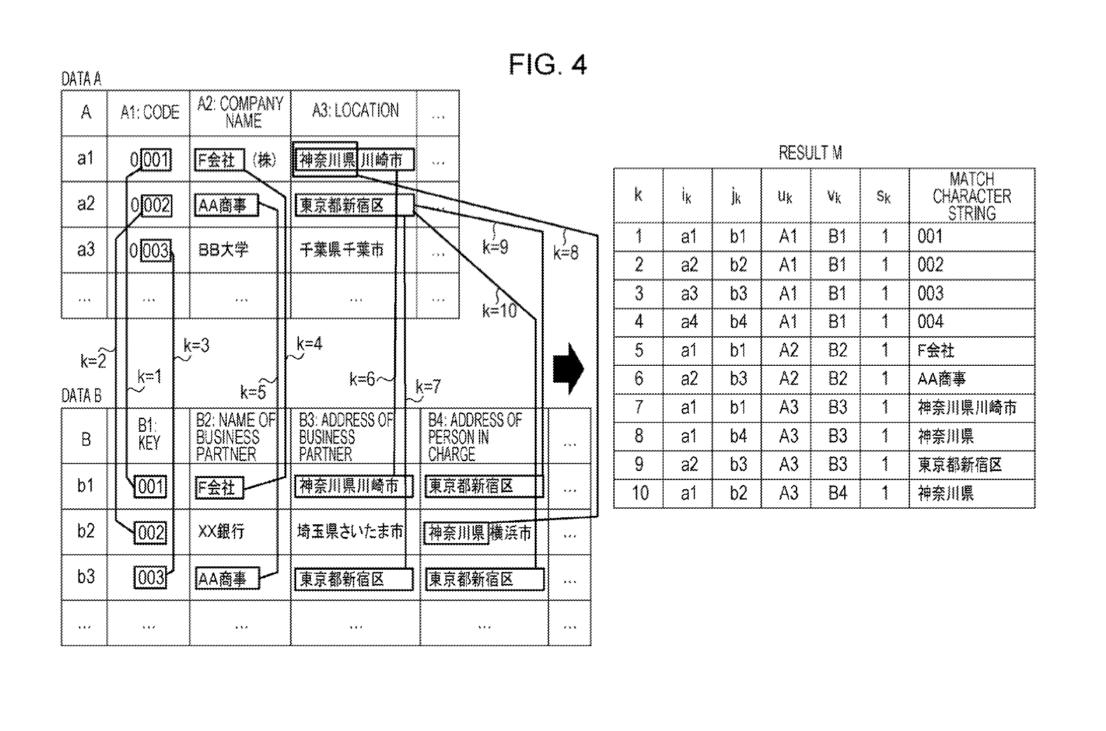

FIG. 4 shows tables illustrating an example of character string match and a result M. In FIG. 4, the table DATA A illustrates an example of character string match and the table RESULT M illustrates an example of the result M of character string match in a table. As illustrated in DATA A, for example, values of cells are compared to one another between two pieces of data and character sting match is executed, thereby detecting match character strings that match between the two pieces of data. In DATA A, an index k is assigned to each match character string in order. Then, the result M of character string match may be expressed by the table of RESULT M. Note that, in RESULT M of character string match of FIG. 4, each entry includes the value of the index k and the elements iₖ, jₖ, uₖ, vₖ, and sₖ of mₖ. Also, in the example of DATA A and RESULT M, the entry further includes a match character string, but there may be a case where the match character string is not included in the result M.

Subsequently, a calculation of the score of a column set and a calculation of the score of a record set using the result M of character string match will be described. Note that, in the following description, the score of the column set is occasionally referred to as P_{c} and the score of the record set is occasionally referred to as Pᵣ.

<Score Calculation>

Assume that the score of a column set (u, v) is expressed by P_{c} (u, v). Also, assume that the score of a record set (i, j) is expressed by Pᵣ (i, j). In this case, P_{c} (u, v) of the column set (u, v) may be expressed by Expression 1 below, using the score Pᵣ (iₖ, jₖ) of each record set (Iₖ, jₖ).

p_{c}(u,v)=Σ_{ks.t.u}_{ₖ}_{=u,v}_{ₖ}₌ᵥpᵣ(iₖ,jₖ)×sₖ Expression 1

Note that, in Expression 1, “s. t.” is, for example, an abbreviation of “subject to”. Then, “k s. t. uₖ=u, vₖ=v” Indicates, for example, that, among entries registered in the RESULT M of FIG. 4, the index k of an entry in which the value of uₖ matches u of a target column set (u, v) the score of which is desired to be obtained, and vₖ matches v is a target of processing. In Expression 1, a value obtained by multiplying the score Pᵣ of the record set of the index k which has been set as a target of processing by sₖ is integrated and an obtained integrated value is the value of the score P_{c} (u, v) of the column set (u, v).

Also, similarly, the score Pᵣ (i, j) of a record set (i, j) may be expressed by Expression 2 below using the score P_{c} (uₖ, vₖ) of each column set (uₖ, vₖ).

pᵣ(i,j)=Σ_{ks.t.i}_{ₖ}_{=i,j}_{ₖ}₌ⱼp_{c}(uₖ,vₖ)×sₖ Expression 2

Note that, in Expression 2, “k s. t iₖ=i, jₖ=j” indicates, for example, that, among entries registered in the RESULT M of FIG. 4, the index k of an entry in which the value of iₖ matches i of a target record set (i, j) the score of which is desired to be obtained and jₖ matches j is a target of processing.

Subsequently, a calculation of each of respective scores of a plurality of column sets between two pieces of data using Expression 1 and a calculation of each of respective scores of a plurality of record sets using Expression 2 will be described. Note that the plurality of column sets may be achieved by making a single column from one of the two pieces of data and a single column from the other one of the two pieces of data into a set and thus forming a plurality of sets of columns. The plurality of record sets may be achieved by making a single record from one of the two pieces of data and a single record from the other one of the two pieces of data into a set and thus forming a plurality of sets of records.

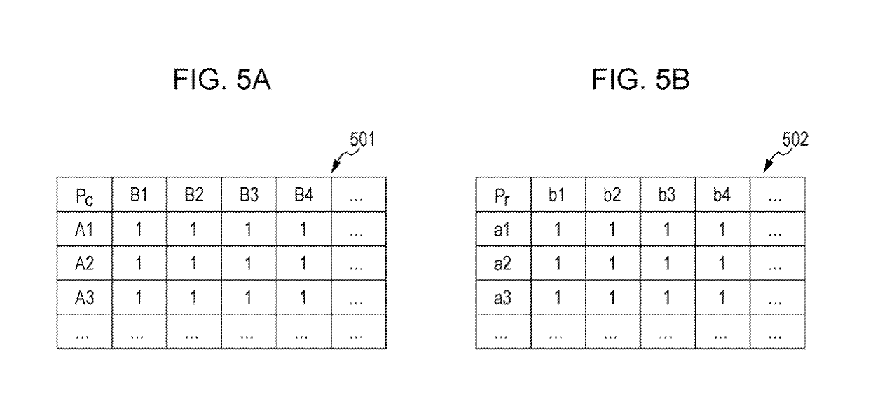

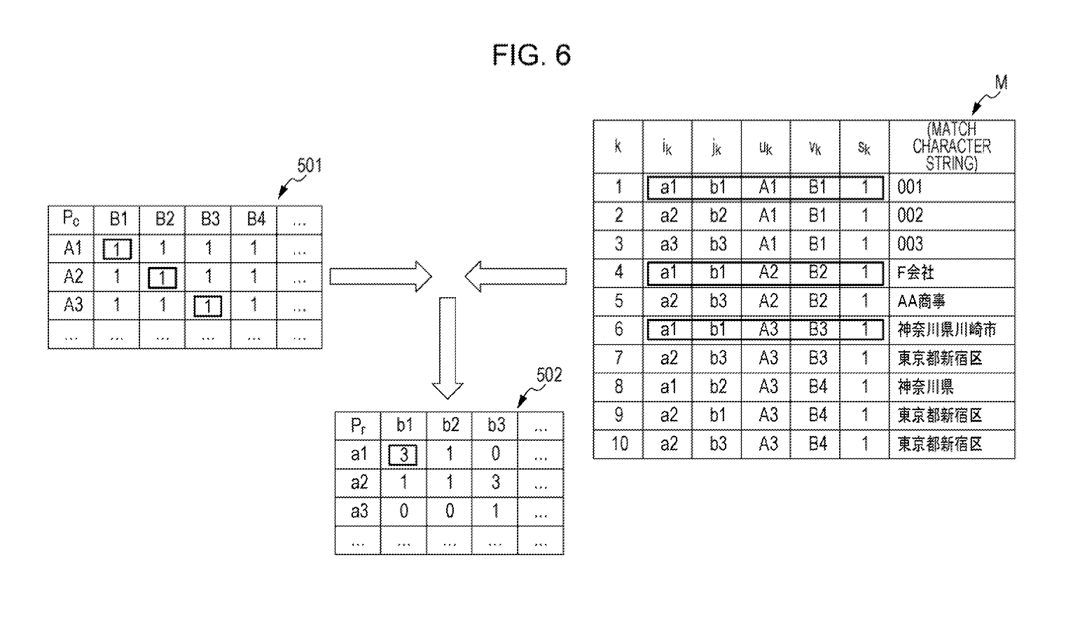

FIGS. 5A and 5B are tables illustrating respective examples of the column set score information 501 and the record set score information 502. FIG. 5A illustrates the column set score information 501 and the score P_{c} (uₖ, vₖ) of each column set (uₖ, vₖ) is registered therein. Note that, in FIG. 5A, a row indicates a column of DATA A and a column indicates a column of DATA B. FIG. 5B illustrates the record set score information 502 and the score Pᵣ (iₖ, jₖ) of each record set (iₖ, jₖ) is registered therein. Note that, in FIG. 5B, a row indicates a record of DATA A and a column Indicates a record of DATA B.

For the column set score information 501 and the record set score information 502, for example, at least one of the tables thereof may be initialized when a score calculation is performed. In score initialization, for example, the control unit 301 may be configured to initialize all of scores to a common value (for example, “1” as illustrated in FIGS. 5A and 5B). Note that embodiments are not limited thereto and, for example, a large value may be set for a column set columns of which are expected to be associated in advance or a record set records of which are expected to be associated in advance, when initialization is performed thereon.

FIG. 6 shows tables illustrating an example of a calculation of the score of a record set using scores of column sets. Note that 501, 502 and M in FIG. 6 illustrate an example of a calculation of the score of a record set of i=a1 and j=b1. FIG. 6 illustrates the column set score information 501 that has been initialized and the result M of character string match. The control unit 301 specifies, in the result M, column sets (A1 and B1, A2 and B2, and A3 and B3) of sets (entries of k=1, 4, and 6 of M) formed with uₖ and vₖ, which are indicated in entries of I=a1 and j=b1. Then, the control unit 301 acquires scores (P_{c} (A1, B1), P_{c} (A2, B2), P_{c} (A3, B3)) of the column sets (A1 and 81, A2 and B2, A3 and B3) from the column set score information 501. Furthermore, the control unit 301 integrates a value obtained by multiplying each of the scores (P_{c} (A1, 81), P_{c} (A2, 82), P_{c} (A3, 83)) by sₖ, thereby calculating the score Pᵣ “3” of a record set of i=a1 and j=b1. A calculation expression using Expression 2, which corresponds to FIG. 6, will be given below.

$$\begin{matrix}{p}_{r} ( a 1 , b 1 ) = {\sum }_{ks , t , {i}_{k} = a 1 , {j}_{k} = b 1} {p}_{c} ( {u}_{k} , {v}_{k} ) \times {s}_{k} = {\sum }_{k = 1.4 , 6} {p}_{c} ( {u}_{k} , {v}_{k} ) \times {s}_{k} \\ = {p}_{c} ( A 1 , B 1 ) \times {s}_{1} + {p}_{c} ( A 2 , B 2 ) \times {s}_{4} + {p}_{c} ( A 3 , B 3 ) \times {s}_{6} \\ = 1 \times 1 + 1 \times 1 + 1 \times 1 = 3\end{matrix} \qquad Expression 3$$

A similar calculation is performed, and thereby, the scores Pᵣ of all of record sets (iₖ, jₖ) are calculated. FIG. 6 also illustrates the record set score information 502 in which scores of all of record sets that have been achieved as a result of the calculation are registered.

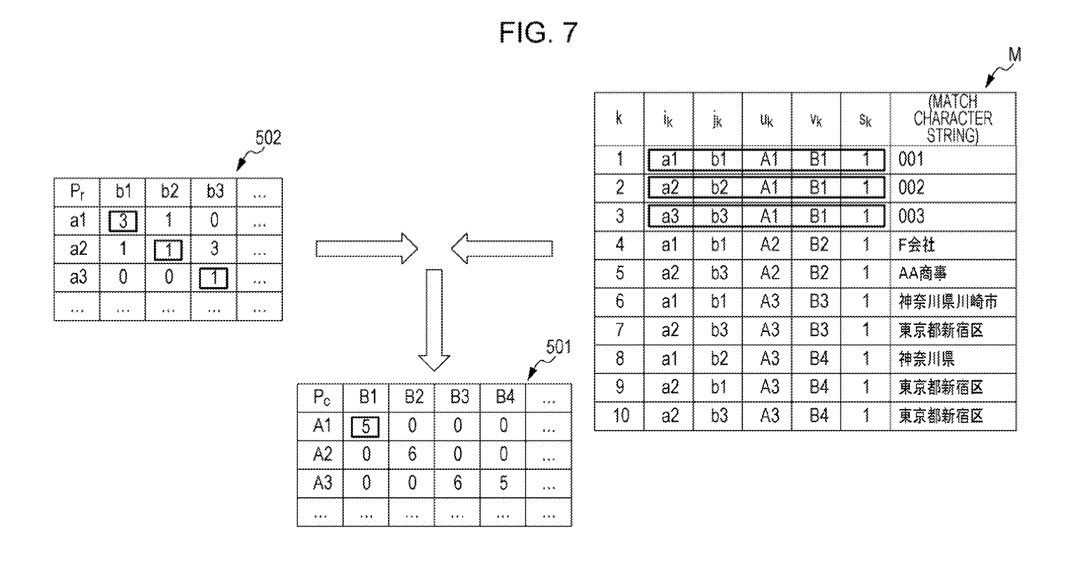

FIG. 7 shows tables illustrating an example of a calculation of the score of a column set using scores of record sets. Note that FIG. 7 illustrate an example of a calculation of the score of a column set of u=A1 and v=B1. In FIG. 7, the record set score information 502 generated in FIG. 6. FIG. 7 illustrates the result M of character string match. The control unit 301 specifies, in the result M, record sets (a1 and b1, a2 and b2, a3 and b3) of sets (entries of k=1, 2, 3 of M) formed with iₖ and jₖ, which are indicated in entries of I=A1 and j=B1. The control unit 301 acquires scores (Pᵣ (a1, b1), Pᵣ (a2, b2), Pᵣ (a3, b3)) of the records sets (a1 and b1, a2 and b2, a3 and b3) from the record set score information 502. Furthermore, the control unit 301 integrates a value obtained by multiplying each of the scores (Pᵣ (a1, b1), Pᵣ (a2, b2), Pᵣ (a3, b3)) by sₖ, thereby calculating the score “5” of a column set of u=A1 and v=B1. A calculation expression that corresponds to FIG. 7 will be given below.

$$\begin{matrix}{p}_{c} ( A 1 , B 1 ) = {\sum }_{ks . t . {u}_{k} = A 1 , {v}_{k} = B 1} {p}_{r} ( {i}_{k} , {j}_{k} ) \times {s}_{k} = {\sum }_{k = 1 , 2 , 3} {p}_{r} ( {i}_{k} , {j}_{k} ) \times {s}_{k} \\ = {p}_{r} ( a 1 , b 1 ) \times {s}_{1} + {p}_{r} ( a 2 , b 2 ) \times {s}_{2} + {p}_{r} ( a 3 , b 3 ) \times {s}_{3} \\ = 3 \times 1 + 1 \times 1 + 1 \times 1 = 5\end{matrix} \qquad Expression 4$$

A similar calculation is performed, and thereby, the scores P_{c} of all of record sets (uₖ, vₖ) are calculated. FIG. 7 illustrates the column set score information 501 in which scores of all of column sets that have been achieved as a result of the calculation are registered.

For example, scores are calculated in the above-described manner, and thereby, scores of column sets may be set such that a higher score is given to a column set in which a cell set including match character strings in a record set the score of which is higher appears. Similarly, scores of record sets may be set such that a higher score is given to a record set in which a cell set including match character strings in a column set the score of which is higher appears. For example, it is enabled to associate a set of columns between pieces of data with high accuracy using the scores of the column sets which have been acquired.

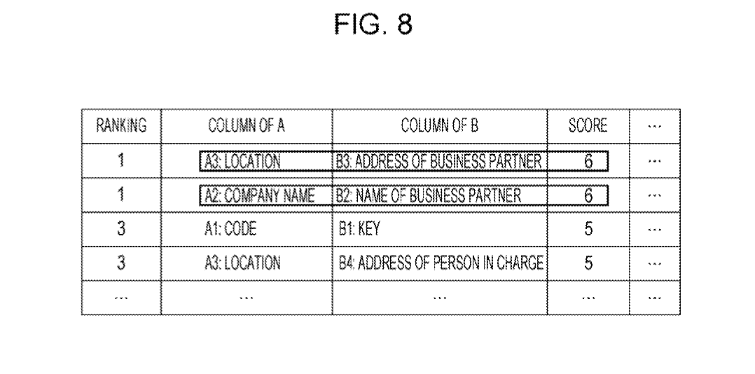

FIG. 8 is a table illustrating an example of ranking of column sets between two pieces of data according to an embodiment FIG. 8 illustrates an example of ranking of column sets using the scores P_{c} of column sets of the column set score information 501 of FIG. 7 and column sets are arranged in the order in which a column set of the score of which is higher is ranked higher. In FIG. 8, a proper set of the column “A3: LOCATION” and the column “B3: ADDRESS OF BUSINESS PARTNER” of DATA B is ranked higher than a set of the column “A3: LOCATION” and the column “B4: ADDRESS OF PERSON IN CHARGE” of DATA B. For example, when similar pieces of data are ranked in accordance with the number of match character strings that have appeared, as Illustrated in FIG. 1B, a proper set of the column “A3: LOCATION” and the column “B3: ADDRESS OF BUSINESS PARTNER” of DATA B is ranked lower than a set of the column “A3: LOCATION” and the column “B4: ADDRESS OF PERSON IN CHARGE” of DATA B. However, according to this embodiment, a high score may be given to a column set of the column “A3: LOCATION” and the column “B3: ADDRESS OF BUSINESS PARTNER” of DATA B, which is a proper column set. Therefore, using scores in the column set score Information 501, the accuracy of column association may be increased.

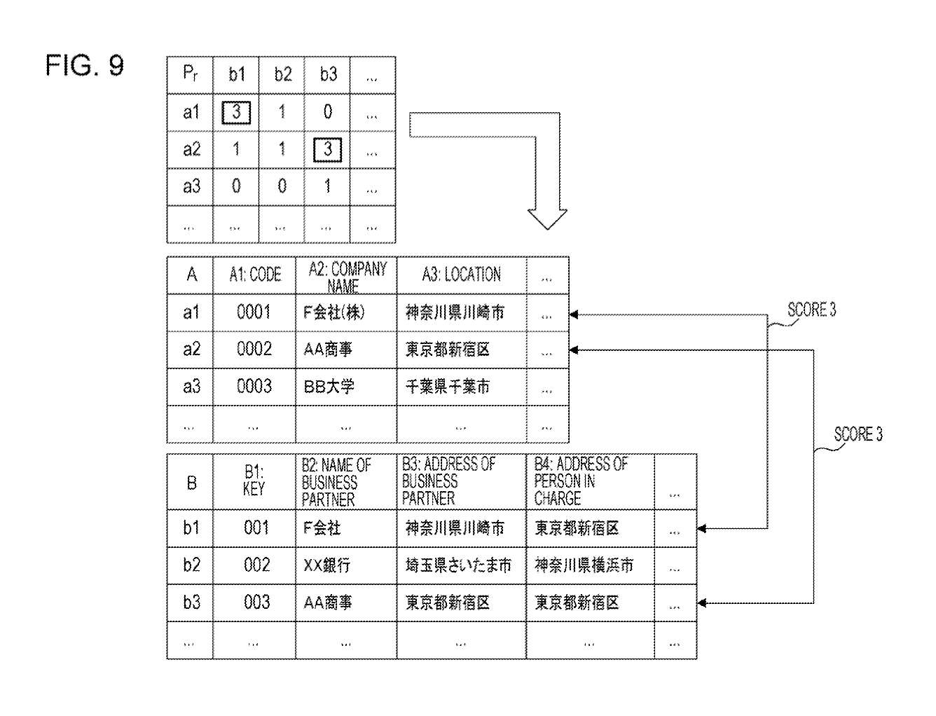

Note that, according to this embodiment, similarly, it is enabled to associate a set of records with high accuracy by using the scores Pᵣ (iₖ, Jₖ) of the record set score information 502. FIG. 9 is a diagram illustrating an example of record set association. As illustrated in FIG. 9, for example, a set of records (a1, b1) and a set of records (a2, b3), each of which indicates a high score “3” in the record set score information 502, may be associated as record sets that are highly likely to be proper sets.

Furthermore, a calculation of the score of a record set using scores of column sets and a calculation of the score of a column set using scores of record sets are alternately repeated, and thereby, accuracy of association of a set of columns and a set of records may be further increased.

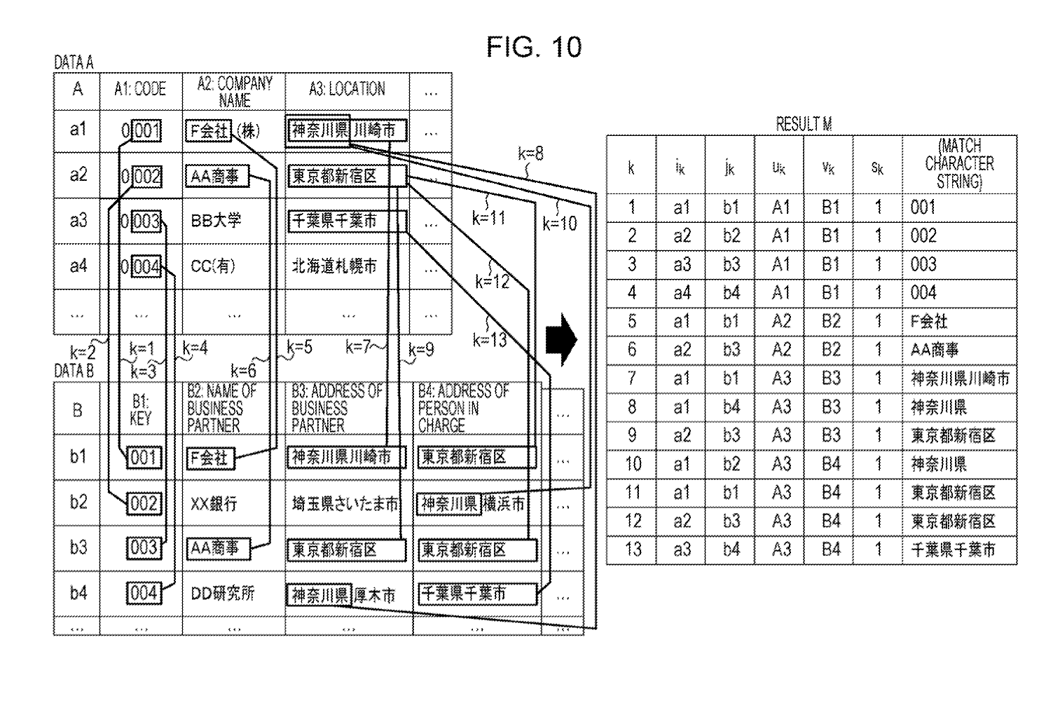

FIG. 10 shows tables illustrating another example of character string match and a result M. FIG. 10 illustrates an example of character string match in DATA A and an example of the result M of character string match in a table RESULT M. As Illustrated in FIG. 10, for example, values of cells are compared to one another between two pieces of data and character sting match is executed, thereby detecting match character strings that match between the two pieces of data. In FIG. 10, an index k is assigned to each match character string in order. Then, the result M of character string match may be expressed by the table of RESULT M. Note that, in the result M of character string match of RESULT M, each entry includes the value of the index k and the elements iₖ, jₖ, uₖ, vₖ, and sₖ of mₖ. Also, in the example of 501 and RESULT M in FIG. 10, the entry further includes a match character string, but there may be a case where the match character string is not included in the result M.

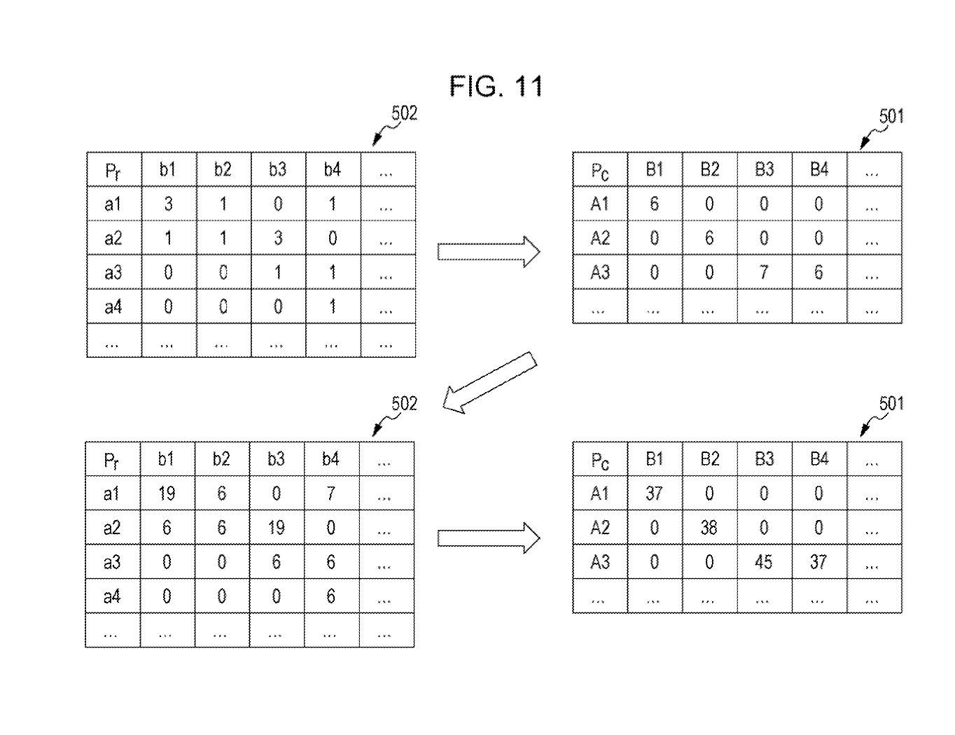

Subsequently, calculations of scores of column sets are performed using the result M. FIG. 11 shows tables each illustrating an example of a calculation of the score of a column set. First, the control unit 301 initializes, for example, the column set score information 501 or the record set score Information 502. Note that, in this case, a case where the column set score information 501 is initialized will be described. For example, as Illustrated in FIG. 5A, the control unit 301 may be configured to initialize each of all of the scores P_{c} of the column set score information 501 to “1”.

Subsequently, the control unit 301 calculates the score Pᵣ of each record set of the record set score information 502, in accordance with Expression 2, using the column set score information 501 that has been initialized. The left-upper table in FIG. 11 is a table Illustrating an example of the record set score information 502 calculated, in accordance with Expression 2, from the column set score information 501 of FIG. 5A.

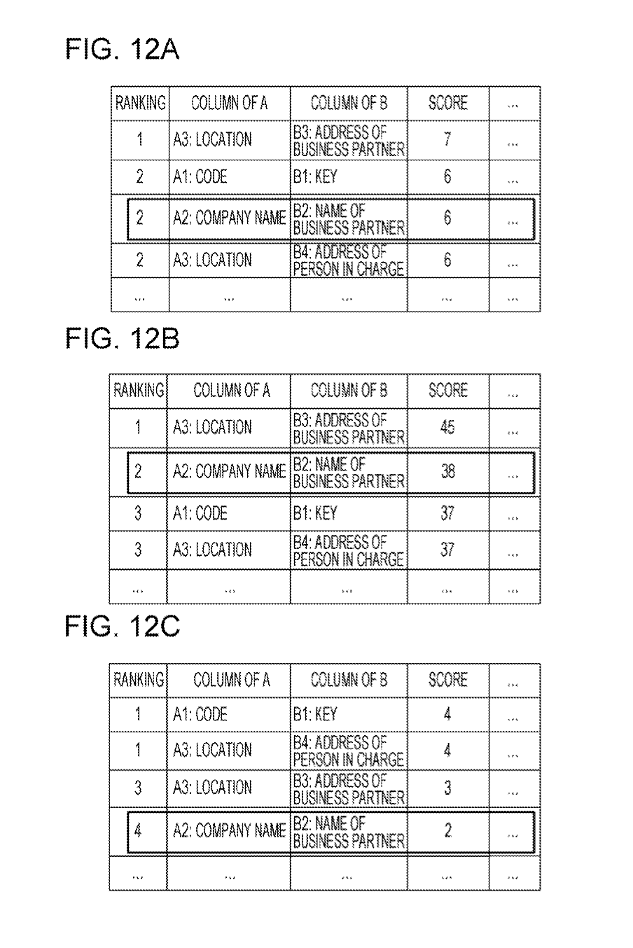

Furthermore, the right-upper table in FIG. 11 illustrates the column set score Information 501 that has been updated from the record set score information 502 using Expression 1. The left-lower table in FIG. 11 Illustrates the record set score information 502 that has been updated from the column set score information 501 using Expression 2, and the right-lower table in FIG. 11 illustrates the column set score information 501 that has been calculated from the record set score information 502 using Expression 1. That is, in FIG. 11, the control unit 301 performs a first update by performing processing as upper half of FIG. 11 on the column set score information 501 of FIG. 5A, which has been initialized, and performs a second update by performing processing up to lower half of FIG. 11. Then, results in which column sets are arranged in the descending order of scores using scores of column sets of the column set score information 501 which have been updated by the first update of FIG. 11 and scores of column sets of the column set score information 501 which have been updated by the second update of FIG. 11 are Illustrated in FIGS. 12A to 12C.

FIGS. 12A to 12C are tables each illustrating an example of ranking of column sets. FIG. 12A illustrates, as an example, a case where column sets of the column set score Information 501 after the first update of FIG. 11 are arranged in the order of scores, and FIG. 12B Illustrates, as an example, a case where column sets of the column set score information 501 after the second update of FIG. 11 are arranged in the order of scores. Note that, similar to FIG. 1B, FIG. 12C illustrates, as an example, a case where column sets are ranked in accordance with the number of match character strings that have appeared and thus arranged.

As Illustrated in FIGS. 12A to 12C, for an entry of a column set of the column “A2: COMPANY NAME” of DATA A and the column “B2: NAME OF BUSINESS PARTNER” of DATA B, after the first update of FIG. 12A, the score is “6” and is the same score as the score of the other second ranking entry. However, after the second update of FIG. 12B, the entry of the column set of the column “A2: COMPANY NAME” of DATA A and the column “B2: NAME OF BUSINESS PARTNER” of DATA B alone is ranked second, and there is a difference from the other entry that was the same second ranking after the first update. As described above, a difference in score is caused to stand out by alternately repeating a calculation of the score of a record set using scores of column sets and a calculation of the score of a column set using scores of record sets, and thereby, accuracy of association of a set of columns may be further increased. Similarly, for association of a set of records, a calculation of the score of a record set using scores of column sets and a calculation of the score of a column set using scores of record sets are alternately repeated, and thereby, accuracy of association may be further increased.

Note that the control unit 301 may be configured to execute alternate repetition of a calculation of the score of a column set and a calculation of the score of a record set, for example, until at least one of the rankings of the column sets or the records sets no longer fluctuate after the calculations are repeated a predetermined number of times.

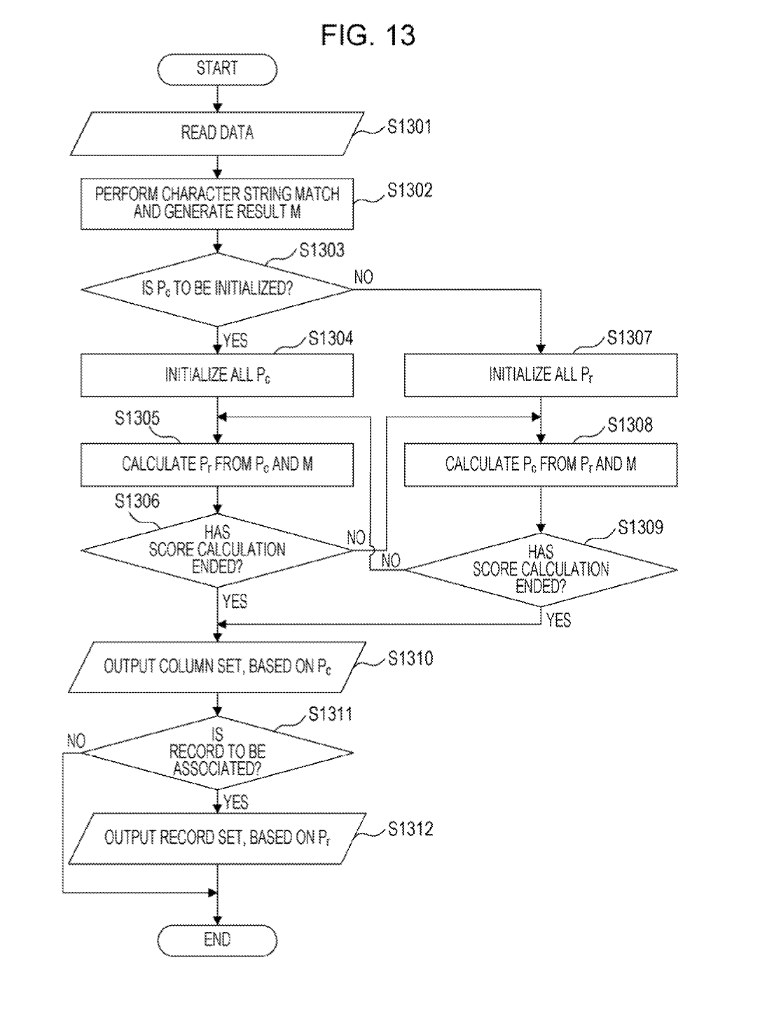

FIG. 13 is a flowchart illustrating an example of an operation flow of evaluation processing according to the above-described embodiment, in which scores of column sets and record sets are calculated. The control unit 301 may be configured to start, for example, when an execution instruction of evaluation processing is Input, the operation flow of FIG. 13.

In Step 1301 (which will be hereinafter referred to as S1301 by describing Step as “S”), the control unit 301 reads a plurality of pieces of data, which are targets on which column association is performed. In S1302, the control unit 301 executes character string match and generates the result M including Information related to match character strings that match between the plurality of pieces of data.

In S1303, the control unit 301 determines whether or not the score P_{c} of each column set, which is registered in the column set score Information 501, is to be initialized. Note that whether an initialization target is to be the column set score information 501 or the record set score information 502 may be determined when an input of a user is received, or may be determined with reference to information that has been set in advance from the storage unit 302. In S1303, when the score P_{c} of each column set is initialized (YES in S1303), the flow proceeds to S1304. In S1304, the control unit 301 initializes the scores P_{c} of all of column sets of the column set score information 501. The control unit 301 may be configured to initialize all of scores to, for example, a common value (for example, “1”). As another option, for example, the control unit 301 may be configured to receive an input made by a user and set a large value to a column set columns of which are expected to be associated in advance.

In S1305, the scores Pᵣ of all of record sets of the record set score information 502 are calculated, using the scores P_{c} of column sets and the result M of character string match, in accordance with Expression 2. Note that, by a calculation of Expression 2, the scores Pᵣ may be set such that a higher score is given to a record set in which a cell set including match character strings in a column set the score of which is higher appears.

In S1306, the control unit 301 determines whether or not a score calculation has ended. The control unit 301 may be configured to repeat a calculation of the score P_{c} of a column set and a calculation of the score Pᵣ of a record set, for example, until at least one of rankings of column sets of the column set score information 501 and record sets of the record set score information 502 no longer fluctuates after the calculations have been repeated a predetermined number of times. Then, the control unit 301 may be configured to determine, when at least one of rankings of column sets of the column set score information 501 and record sets of the record set score information 502 no longer fluctuates, YES in S1306. As another option, the control unit 301 normalizes at least the values of the scores of column sets of the column set score information 501 or the values of the scores of record sets of the record set score information 502. Then, the control unit 301 may be configured to determine, if, while repeating calculations, a change in a normalized value is lower than a predetermined threshold, YES in S1306. Note that, for example, for column sets, the normalization may be performed by performing constant multiplication such that the sum of the scores P_{c} of the column set score information 501 is 1. Similarly, the scores Pᵣ may be normalized.

In S1306, if a score calculation has not ended (NO in S1306), the flow proceeds to S1308. In S1308, using the scores P, of record sets and the result M of character string match, the control unit 301 calculates the scores P_{c} of all of column sets of the column set score information 501 in accordance with Expression 1. By a calculation of Expression 1, the scores P_{c} may be set such that a higher score is given to a column set in which a cell set including match character strings in a record set the score of which is higher appears.

In S1309, the control unit 301 determines whether or not a score calculation has ended. For example, the control unit 301 may be configured to perform, in S1309, similar determination to determination performed in S1306. In S1309, if a score calculation has not ended (NO in S1309), the flow returns to S1305.

Also, in S1303, if the scores P_{c} are not to be initialized (NO in S1303), the follow proceeds to S1307. In S1307, the control unit 301 initializes the scores Pᵣ of all of record sets of the record set score information 502. The control unit 301 may be configured to initialize all of the scores to a common value (for example, “1”). As another option, for example, the control unit 301 may be configured to receive an input made by a user and set a large value to a column set columns of which are expected to be associated in advance.

Also, in S1306 or S1309, if the control unit 301 determines that a score calculation has ended (YES in S1306 or S1309), the flow proceeds to S1310. In S1310, the control unit 301 outputs a column set, based on the scores P_{c} of column sets registered in the column set score information 501. For example, the control unit 301 may be configured to output only a predetermined number of ones of entries of the column set score information 501, which have high ranking from the top. As another option, the control unit 301 may be configured to output a column set having the highest score to each column of one of a plurality of pieces of data that are targets on which column association is performed.

In S1311, the control unit 301 determines whether or not a record is to be associated. Note that whether or not a record is to be associated may be determined when an input of a user is received, or may be determined with reference to information indicating whether or not a record that has been stored in the storage unit 302 in advance is to be associated.

If a record is not to be associated (NO in S1311), this operation flow ends. On the other hand, if a record is to be associated (YES in S1311), the flow proceeds to S1312.

In S1312, the control unit 301 outputs a record set, based on the scores Pᵣ of record sets registered in the record set score information 502. For example, the control unit 301 may be configured to output a predetermined number of record sets that have high scores in the record set score Information 502. As another option, the control unit 301 may be configured to output a record set that has the highest score to each record of one of a plurality of pieces of data. When the control unit 301 outputs association with a record in S1312, this operation flow ends.

Note that, in processing of S1302 of the operation flow of FIG. 13, the control unit 301 operates, for example, as the comparison unit 311. Also, in processing of S1308, the control unit 301 operates, for example, as the setting unit 312.

As described above, according to this embodiment, the control unit 301 performs a calculation of Expression 1, and thereby, is enabled to set the scores P_{c} such that a higher score is given to a column set in which a cell set including match character strings in a record set the score of which is higher appears. Therefore, column association is performed in accordance with the given scores, and thereby, columns may be associated with one another between pieces of data with high accuracy. Also, according to this embodiment, even without using other information than the value of data, columns may be associated with one another between pieces of data with high accuracy.

Similarly, in the above-described embodiment, the control unit 301 performs a calculation of Expression 2, and thereby, is enabled to set the scores Pᵣ such that a higher score is given to a record set in which a cell set including match character strings in a column set the score of which is higher appears. Therefore, record association is performed in accordance with the given scores, and thereby, records may be associated with one another between pieces of data with high accuracy. Also, according to this embodiment, even without using any other information than the value of data, records may be associated with one another between pieces of data with high accuracy.

Also, as described in the above-described embodiment, a calculation of the score of a record set using scores of column sets and a calculation of the score of a column set using scores of record sets are alternately repeated, and thereby, accuracy of association may be further increased.

Therefore, according to the embodiment, columns may be associated with one another between a plurality of pieces of data with high accuracy.

Note that the control unit 301 may be configured to store the column set score information 501 and the record set score information 502 that have been achieved as a result in the storage unit 302 as they are. As another option, for example, a configuration in which, from all of column sets of the column set score information 501 and all of record sets of the record set score information 502, only a column set and a record set the score of which is not 0 are extracted and stored in the storage unit 302 may be employed.

Also, for example, there may be a case where, when there are DATA A and DATA B that are targets on which column association is performed, a column of DATA A corresponds to a plurality of columns of DATA B. For example, there may be a case where the column “A2: ADDRESS” of DATA A is divided into columns “B7: PREFECTURE/COUNTRY”, “B8: CITY/TOWN”, and “B9: STREET/HOUSE NUMBER” and thus held in DATA B. In such a case, the embodiment may be applied, for example, by combining an arbitrary number of columns together and assigning a new column thereto. For example, it is enabled to associate the column “B10” of DATA B and “A2: ADDRESS” of DATA A by assigning a column “B10” to data obtained by combining pieces of data of the column “B7: PREFECTURE/COUNTRY”+“B8: CITY/TOWN”+“B9: STREET/HOUSE NUMBER”.

Furthermore, although, in the above-described embodiment, a case where association between two pieces of data is performed has been described as an example, embodiments are not limited thereto. For example, the embodiment may be applied to column or record association between three or more pieces of data. For example, a match character sting set between N pieces of data is employed as an input and each of the numbers of arguments of P_{c} and Pᵣ is set to be N, so that association between N pieces of data is possible. For example, when name Identification is performed between three pieces of data, a match result is set to be a set of (iₖ, jₖ, lₖ, uₖ, vₖ, wₖ, and sₖ) and each of respective scores are extended to the corresponding one of P_{c} (uₖ, vₖ, wₖ) and Pᵣ (iₖ, jₖ, lₖ), so that the embodiment may be applied.

In the description above, an embodiment has been described, but embodiments are not limited thereto. For example, the above-described operation flow is provided merely for illustrative purpose and embodiments are not limited thereto. In a possible case, the operation flow may be also executed in a changed order, and may further include another processing, and a part of processing may be omitted.

Also, for example, in the above-described embodiment, in S1301 to S1302, data that is a target on which column association is performed is read out and then character string match is executed. However, embodiments are not limited thereto. For example, character string match may be executed in another device, the operation flow may be started with S1303, and a result of character string match executed in the another device may be used.

Also, in another embodiment, a result of record association is output, and a result of column association is not output.

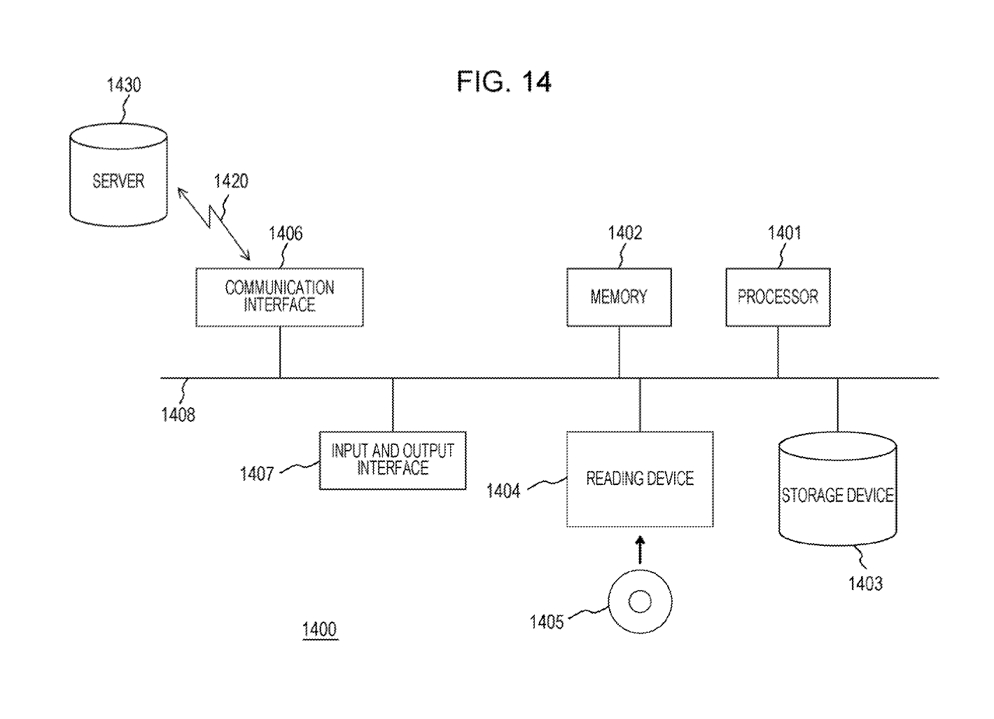

FIG. 14 is a diagram illustrating an example of a hardware configuration of a computer 1400 that realizes the information processing device 300 according to an embodiment. The hardware configuration that realizes the information processing device 300 of FIG. 14 includes, for example, a processor 1401, memory 1402, a storage device 1403, a reading device 1404, a communication interface 1406, and an input and output Interface 1407. Note that the processor 1401, the memory 1402, the storage device 1403, the reading device 1404, the communication interface 1406, and the input and output interface 1407 are coupled to one another via a bus 1408.

The processor 1401 executes, for example, a program in which processes of the above-described operation flow are described using the memory 1402, and thereby, provides some or all of functions of the control unit 301. For example, the processor 1401 executes a program in which, for example, processes of the above-described operation flow are described using the memory 1402, and thereby, operates as the comparison unit 311 and the setting unit 312. Also, the storage unit 302 includes, for example, the memory 1402, the storage device 1403, and a removable storage medium 1405. For example, data that is a target on which column association is performed, the result M of character string match, the column set score information 501, and the record set score information 502 may be stored in the storage device 1403.

The memory 1402 may be, for example, semiconductor memory and include a RAM area and a ROM area. The storage device 1403 is, for example, semiconductor memory, such as a hard disk, flash memory, or the like, or an external storage device. Note that RAM is an abbreviation of random access memory. Also, ROM is an abbreviation of read only memory.

The reading device 1404 accesses the removable storage medium 1405 in accordance with an Instruction of the processor 1401. The removable storage medium 1405 is realized, for example, by a semiconductor device (USB memory or the like), a medium (a magnetic disk or the like) to and from which information is input and output by magnetic effects, a medium (CD-ROM, DVD, or the like) to and from which information is input and output by optical effects, or the like. Note that USB is an abbreviation of universal serial bus. CD is an abbreviation of compact disc. DVD is an abbreviation of digital versatile disk.

The communication interface 1406 transmits and receives data via a network 1420 in accordance with an instruction of the 1401. The input and output interface 1407 may be, for example, an interface between an input device and an output device. The input device is, for example, a device, such as a keyboard, a mouse, or the like, which receives an instruction of a user. The output device is, for example, a display device, such as a display or the like, or an audio device, such as a speaker or the like.

Each program according to the embodiment is provided to the information processing device 300 in any of the following forms.
(1) A form in which each program is installed in the storage device 1403 in advance.
(2) A form in which each program is provided by the removable storage medium 1405.
(3) A form in which each program is provided from a server 1430, such as a program server.

Note that the hardware configuration of the computer 1400 that realizes the information processing device 300, which has been described with reference to FIG. 14, is provided merely for illustrative purpose, and embodiment are not limited thereto. For example, some or all of functions of the above-described function units may be each mounted as a hardware by FPGA, SoC, or the like. Note that FPGA is an abbreviation of field programmable gate array. SoC is an abbreviation of system-on-a-chip.

The processor 1401 of the computer 1400 reads out and executes a program in which, for example, processes of the above-described operation flow are described, and thereby, columns may be associated with one another with high accuracy. As a result, for example, a record set that is not used is not stored in the storage device 1403, and therefore, a storage capacity of the storage device 1403, which may be used, may be increased. Also, processing costs of accessing a record that is not used may be reduced.

In the description above, some embodiments have been described. However, embodiments are not limited to the above-described embodiments and are to be understood to include various modified embodiments and alternative embodiments of the above-described embodiments. For example, it is to be understood that each of various embodiments may be achieved by modifying components to an extent not departing from the first and scope of the present disclosure. Also, it is to be understood that a plurality of components disclosed in the above-described embodiments may be combined, as appropriate, so that various embodiments may be executed. Furthermore, it is also to be understood by those skilled in the art that various embodiments may be performed by removing or replacing some of components from all of the components described in the embodiments, or adding some components to the components described in the embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable and non-transitory storage medium that stores an evaluation program that causes an information processing device to execute a process, the process comprising:
comparing values of cells between a plurality of pieces of data each including a plurality of cells divided by a plurality of columns and a plurality of records;
storing, in a memory, information that Indicates a plurality of cell sets that have been detected as sets of cells including similar character strings by the comparing; and
setting, with reference to the memory, a score of each of a plurality of column sets formed by making each of columns of one of the plurality of pieces of data and each of columns of another one of the plurality of pieces of data as a set, based on a score for a record set of records in which a cell set, among the plurality of cell sets, which is included in the column set, is included.

2. The storage medium according to claim 1,
wherein the process further includes setting a score of each of a plurality of record sets formed by making each of records of one of the plurality of pieces of data and each of records of another one of the plurality of pieces of data as a set, based on a score for the column set of columns in which a cell set, among the plurality of cell sets, which is included in the record set is included.

3. The storage medium according to claim 2,
wherein the process further includes executing alternate repetition of setting of the score of each of the plurality of column sets and setting of the score of each of the plurality of record sets until at least one of a ranking in accordance with the scores of the plurality of column sets and a ranking in accordance with the scores of the plurality of record sets no longer changes after the repetition has been executed a predetermined number of times.

4. The storage medium according to claim 1,
wherein a value of a cell of one column of one data of the plurality of pieces of data is a value obtained by combining values of cells of other columns included in the one data.

5. An Information processing device comprising:
memory; and
a processor that is coupled to the memory and performs a process, the process including
comparing values of cells between a plurality of pieces of data each Including a plurality of cells divided by a plurality of columns and a plurality of records;
storing, in memory, information that Indicates a plurality of cell sets that have been detected as sets of cells including similar character strings by the comparing, and
setting, with reference to the memory, a score of each of a plurality of column sets formed by making each of columns of one of the plurality of pieces of data and each of columns of another one of the plurality of pieces of data as a set, based on a score for a record set of records in which a cell set, among the plurality of cell sets, which is included in the column set is included.

6. An evaluation method which is executed by a processor, the method comprising:
comparing values of cells between a plurality of pieces of data each including a plurality of cells divided by a plurality of columns and a plurality of records;
storing, in a storage unit, information that indicates a plurality of cell sets that have been detected as sets of cells including similar character strings by the comparing; and
setting, with reference to the storage unit, a score of each of a plurality of column sets formed by making each of columns of one of the plurality of pieces of data and each of columns of another one of the plurality of pieces of data as a set, based on a score for a record set of records in which a cell set, among the plurality of cell sets, which is included in the column set is included.
